(19) United States
(12) Patent Application Publication
(10) Pub. No.: US 2003/0036369 A1
(43) Pub. Date: Feb. 20, 2003

(54) Intrinsic pavement transmitter and antenna

(76) Inventors: Andrew W. Buffmire, Berwyn, PA (US); George A. Mealey, Salt Lake City, UT (US)

Correspondence Address: MICHAEL W. STARKWEATHER, JONES, WALDO, HOLBROOK & McDONOUGH, Suite 1500, 170 South Main Street, Salt Lake City, UT, 84101-1644, US

(21) Appl. No.: 09/932,870

(22) Filed: Aug. 17, 2001

(51) Int. Cl. H04B 1/00

(52) U.S. Cl. 455/129; 455/91

(57) ABSTRACT

A radio communications system is disclosed having an intrinsic pavement transmitter and antenna. A first transmitter/receiver is located at a first point along the intrinsic pavement transmitter and antenna, and is in communication with a user. A second transmitter/receiver is located at a second point along the intrinsic pavement transmitter and antenna, and is in communication with an end-user. The intrinsic pavement transmitter and antenna conducts radio frequency signals between the first and second transmitter/receiver. An intrinsic pavement transmitter and antenna is also disclosed. The intrinsic pavement transmitter and antenna comprises a roadway having a suitable wearing course material and an effective amount of radio frequency conductive material, sufficient to transmit and receive radio frequencies.

### FIELD OF THE INVENTION

The present invention relates generally to a telecommunications infrastructure system, and more particularly to an infrastructure system utilizing conductive paving materials as a conductor and transmitter of radio frequencies.

### BACKGROUND OF THE INVENTION

The last link of connectivity between end-users of telecommunications services and the public switched telephone network (PSTN) is commonly referred to as the “last mile.” Connectivity across the last mile, and particularly broadband telecommunications connectivity, is the primary impediment to the development of a fully competitive telecommunications industry. To illustrate, a high bandwidth nationwide fiber-optic broadband infrastructure is now in place. However, approximately 93% of current fiber optic capacity remains unused in significant part because of limited broadband end-user connectivity.

In the current telecommunications infrastructure, last mile connectivity is made primarily through twisted pair copper lines, owned and controlled by existing local telephone companies. Twisted pair copper lines have a number of inherent limitations that make them unsuitable for last mile connectivity. First, twisted pair copper lines have inherent capacity and connectivity constraints that limit their effectiveness as a path for end-user broadband connectivity. Second, as a result of the virtually universal ownership of last mile connectivity by existing local telephone companies, a new competitor must either over-build the existing infrastructure, or seek to resell capacity on the existing infrastructure. Over-building of the existing copper line twisted pair infrastructure is uneconomical due to easement and right-of-way requirements, as well as the ubiquitous nature of the existing infrastructure. Resale of the existing twisted pair infrastructure would require multiple end office connection points to allow broad geographic coverage. Such connections make resale of the existing carrier networks impractical. In addition, given the imbedded cost structure, and lack of an alternative competitive path to the end-user, sale for resale prices for the existing network have been, and remain, too high to support a viable business plan.

One alternative to the existing pair copper line infrastructure is a direct fiber optic connection. Fiber optic connections provide high bandwidth and high speed telecommunications connectivity. However, fiber to end-user connections are not economical except for large buildings or perhaps commercial end-users because of their high cost of deployment. They are also oftentimes impractical because of the unavailability of required easements or rights-of-way and the need to connect to an end-user through an existing building's infrastructure, which may be owned by a third party landlord.

Another alternative to the existing twisted pair copper line infrastructure is cable modems. Cable modems can provide high bandwidth access, but can only do so over cable networks that have been upgraded to provide for two-way connectivity. This is a costly upgrade, and, as a practical matter has been, and will be, limited to that part of the existing cable infrastructure for which it will generate an economic return. Additionally, voice transmission quality can vary significantly over cable transmission systems and cable modem speeds are variable and decrease as the network is loaded.

Wireless broadcast communications are a third alternative to copper line infrastructure. However, wireless broadcast communications become cost prohibitive because the high bandwidth connectivity requires costly in-fill infrastructure. Wireless point to point communication is also costly and inadequate because it generally requires line-of-sight connectivity, and accordingly is limited in its application in each market in which it is deployed.

In addition to “last mile” issues, the current telecommunications infrastructure is not well suited for broad geographic connectivity. In other words, the existing infrastructure only provides connectivity in remote areas at a high or non-compensatory cost. Furthermore, the existing infrastructure does not adequately provide for areas that regulate or otherwise restrict the erection of towers or antennas for the promulgation of wireless services (for example, National Parks or Forest Service lands).

Accordingly, an infrastructure system that provides broad geographic connectivity, without using or relying upon the existing last mile connectivity infrastructure, as well as high potential bandwidth availability, while at the same time being cost effective in its commercial application, would be desirable.

Prior Art Examples of patents related to the present invention, each of which is incorporated by reference for its supporting teachings, are as follows:

U.S. Pat. No. 6,091,025 to Cotter, et al. teaches a cable system which can accommodate electrical and optical cabling. The conductors of the system employ a layer which is impedance-matched to space, decreasing their cross-section to electromagnetic interference. The conductors of the system also employ a layer which symmetrizes electromagnetic interference signals, reducing the effect of interference and crosstalk on the signals carried by the conductors. The system also includes a node interface device for connection to a global electrical and fiber network. The node interface device connects to a user interface device through the cable.

U.S. Pat. No. 6,071,039 to Ogura, et al. teaches a roadbed layer formed having a cushion layer of 50 mm to 200 mm in thickness which is formed by using elastic chips alone or in mixture with sand. The elastic chips are formed of elastic material and have a size of 7 mm to 0.05 mm, preferably 2 mm to 0.5 mm and a specific gravity of 1.8 to 3.5. The cushion layer contains elastic chips of 3 wt % or more. The elastic chips are formed by mixing a material selected from the group consisting of synthetic rubber, natural rubber and synthetic resin with a specific gravity adjusting material of inorganic powder having a specific gravity of 3 or more.

U.S. Pat. No. 5,648,490 to Thalhammer, et al. teaches a process for the preparation of 5-formylaminopyrimidines.

U.S. Pat. No. 5,460,649 to Strassman teaches a fiber-reinforced rubber asphalt concrete composition suitable for paving applications and a method of making the composition. Also provided is a method for converting a conventional asphalt plant to one capable of producing the fiber-reinforced rubber asphalt concrete composition of the invention and an apparatus suitable for doing same.

U.S. Pat. No. 5,395,673 to Hunt teaches a non-slip composition for application to a ground surface where lighting conditions may be poor. The composition includes a polymer epoxy having two parts of diglycidyl ether resin and one part aliphatic amine adduct modified with 30% AEP as a stabilizer. A phosphorescent pigment including zinc, sulfide, and copper may be mixed with the epoxy to provide luminescent characteristics thereto. During application, a clear aluminum oxide aggregate is spread across a layer of the applied epoxy prior to curing, thereby enhancing the light emitting properties of the phosphorescent pigment as well as providing non-slip characteristics to the exposed surface of the applied layer of epoxy.

U.S. Pat. No. 4,356,037 to Novak teaches an abrasion resistant coating comprising a binder having dispersed therein first abrasion-resistant particles of substantially uniform size and second abrasion-resistant particles of substantially uniform size, the second particles having diameters of less than 15.4% of the first particles, the combined volume of the second particles and binder being at least about equal to the void volume of the first particles, the volume of the binder being at least equal to the combined void volumes of the first and second particles when they are inter-dispersed with one another.

U.S. Pat. No. 4,272,211 to Sabel teaches a wear-resistant element, particularly in the form of a slab intended to be used as covering in areas exposed to excessive wear. The slab includes a hard wear metal of a hardness exceeding 400 Brinell, said wear-metal being in the form of granules which are embedded into a bonding agent consisting of synthetic resin, ceramic materials, rubber, or a combination of these materials. Preferably, the granules are arranged to agglomerate adjacent the wear face of the slab, whereas the concentration of wear metal towards the bottom of the slab is essentially nil. The resulting slab thus uses less amounts of the expensive wear-resistant material, and at the same time it is lighter than prior-art slabs and easier to manufacture.

U.S. Pat. No. 4,094,697 to Rostler teaches improved asphalt cements and bituminous paving compositions containing certain reinforcing filler compositions which impart desirable properties thereto. The filler compositions of the invention are asphalt-dispersible pellets comprising certain carbon blacks which have been treated with certain non-volatile petroleum oils.

U.S. Pat. No. 2,948,201 to Nagin, et al. teaches a pavement composition and method for producing the same.

U.S. Pat. No. 2,077,749 to Fischer teaches a paving construction having means embedded in the tread surface of the pavement to prevent skidding of vehicles.

U.S. Pat. No. 500,273 to Schlichting teaches a pavement suitable for roads.

None of the foregoing prior art references teach an infrastructure system that provides broad geographic telecommunications connectivity, without using or relying upon the existing last mile connectivity infrastructure, as well as high potential bandwidth availability, while at the same time being cost effective in its commercial application.

### SUMMARY OF THE INVENTION

There is therefore provided a telecommunications infrastructure system utilizing conductive paving materials as a conductor and transmitter of radio frequencies. The telecommunications infrastructure system is a radio communications system having an intrinsic pavement transmitter and antenna. A first transmitter/receiver is located at a first point along the intrinsic pavement transmitter and antenna. This first transmitter/receiver is in communication with a user. A second transmitter/receiver is located at a second point along the intrinsic pavement transmitter and antenna, and is in communication with an end-user. The intrinsic pavement transmitter and antenna conducts radio frequency signals between the first and second transmitter/receiver.

In one embodiment, the second transmitter/receiver communicates with the end-user through a hard wire. In another embodiment, the second transmitter/receiver communicates with the end-user through radio frequencies.

An intrinsic pavement transmitter and antenna is also disclosed. The intrinsic pavement transmitter and antenna comprises a roadway, including a suitable wearing course material and an effective amount of radio frequency conductive material, sufficient to transmit and receive radio frequencies. In one embodiment, the radio frequency conductive material can consist of radio frequency transmittable polymers, metal shavings, metal dust, conductive carbons or mixtures thereof.

Examples of suitable conductive carbons include carbon black, carbon fiber, graphite and coke breeze. Examples of suitable polymers include polyacetylene, polyaniline, polypyrrole, polythiophenes, polyethylenedioxythiophene and poly(p-phenylene vinylene)s. Examples of suitable metal shavings include iron shavings, iron alloy shavings, aluminum shavings, aluminum alloy shavings, copper shavings and copper alloy shavings. Dusts of similar metals may also be used.

In one embodiment the wearing course material is asphalt. However, it is noted that concrete may also be used. In one embodiment, the conductive material is intermixed with the wearing course material. In another embodiment, the conductive material and the wearing course material exist as substantially distinct layers.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

FIG. 1 is a cross-sectional view of an embodiment of the intrinsic pavement transmitter and antenna according to the present invention.

FIG. 2 is a cross-sectional view of another embodiment of the intrinsic pavement transmitter and antenna according to the present invention.

FIGS. 3(a) and (b) are cross-sectional views of embodiments of the intrinsic pavement transmitter and antenna.

FIGS. 4(a) and (b) are schematic representations of the radio communication system according to the present invention.

### DETAILED DESCRIPTION OF THE PREFERRED EMBODIMENT(S)

The present invention relates generally to a telecommunications infrastructure system, and more particularly to an infrastructure system utilizing conductive paving materials as a conductor and transmitter of radio frequencies.

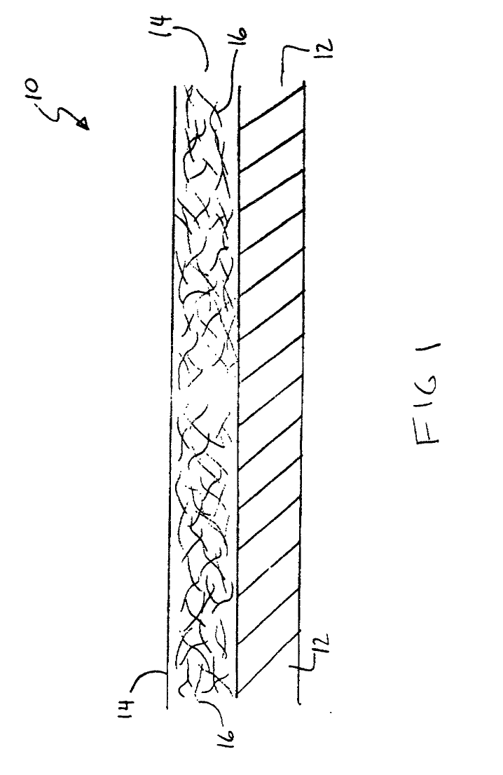

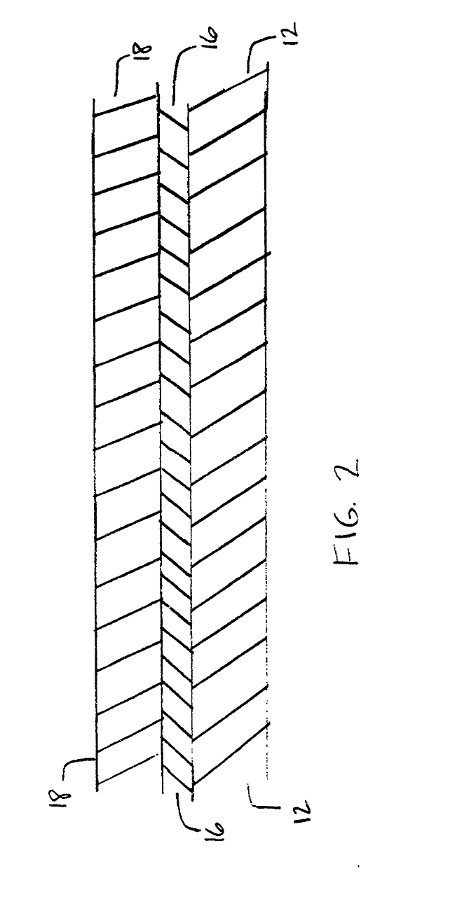

In FIGS. 1 and 2, there are shown two embodiments of the intrinsic pavement transmitter and antenna according to the present invention. FIG. 1 identifies an intrinsic pavement transmitter and antenna 10 in cross-section. The first layer is the roadbed layer 12. The roadbed layer 12 is most commonly natural soil. However, various other suitable roadbed layer materials would be known to one skilled in the art. The next layer is the conductive roadway 14. It is noted that in FIG. 1, the radio frequency conductive roadway layer 14 is shown sitting directly atop the roadbed layer 12. However, it would be apparent to one skilled in the art that one or more base course layers could be placed between the roadbed layer 12 and the roadway 14.

It is also noted that the term roadway as used herein is not intended to limit the application of the present invention to roads only. Any paved surfaces, including bridges, walkways and parking facilities, are considered to be within the scope of the term roadway.

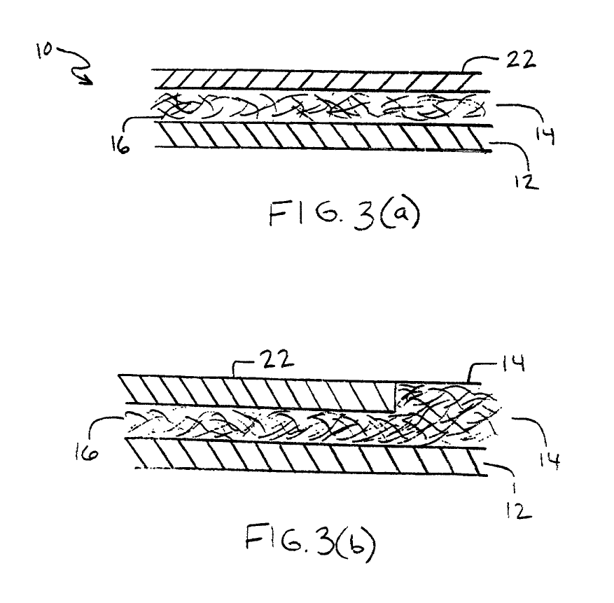

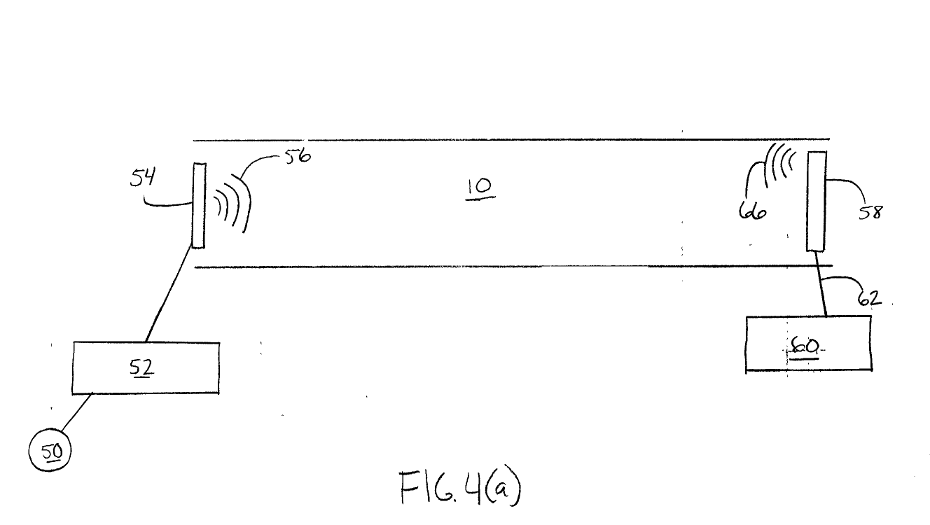

The roadway 14 is composed of a wearing course material intermixed with an effective amount of radio frequency conductive material 16. As is shown in FIGS. 1 and 3, the radio frequency conductive material 16 forms a continuous network of conducting pathway sufficient to transmit and receive radio frequencies. Numerous frequency conductive materials 16 would be suitable for the present invention. Specific examples of conductive materials 16 include, but are not limited to, radio frequency transmittable polymers, metal shavings, metal dust and conductive carbons.

Virtually any conductive carbons could be selected as the conductive materials. Carbon black, carbon fiber, graphite and coke breeze are examples of suitable conductive carbons. Polyacetylene, polyaniline, polypyrrole, polythiophenes, polyethylenedioxythiophene and poly(p-phenylene vinylene)s are examples of conductive polymers that would be suitable for use with the embedded pavement antenna. The metal shavings and dusts could be derived from iron, iron alloys, aluminum, aluminum alloys, copper and copper alloys, or virtually any other conductive metal. Suitable wearing course materials include, but are not limited to, asphalt and concrete.

In FIG. 1 the roadway layer 14 is composed of a wearing course material intermixed with an effective amount of radio frequency conductive material 16. However, in an alternative embodiment, the wearing course material 18 is a substantially separate layer from the radio frequency conductive material 16. This embodiment is shown in FIG. 2.

By incorporating a conductive material into a paved surface in this manner, much broader geographic connectivity can be accomplished. There already exists an expansive asphalt roadway infrastructure that could be utilized with the present invention. Furthermore, the wide transmitting medium (i.e. the paved surface) has high potential bandwidth availability.

FIGS. 3(a) and (b) show other embodiments of an intrinsic pavement transmitter and antenna 10. In FIG. 3(a) an additional insulating layer 22 is shown overlaying the conductive layer 14. In FIG. 3(b), a partially insulating layer 22 is shown. Non-conductive asphalt or non-conductive concrete could serve as the insulating layer 22. However, numerous other suitable insulating layers would be apparent to one of skill in the art.

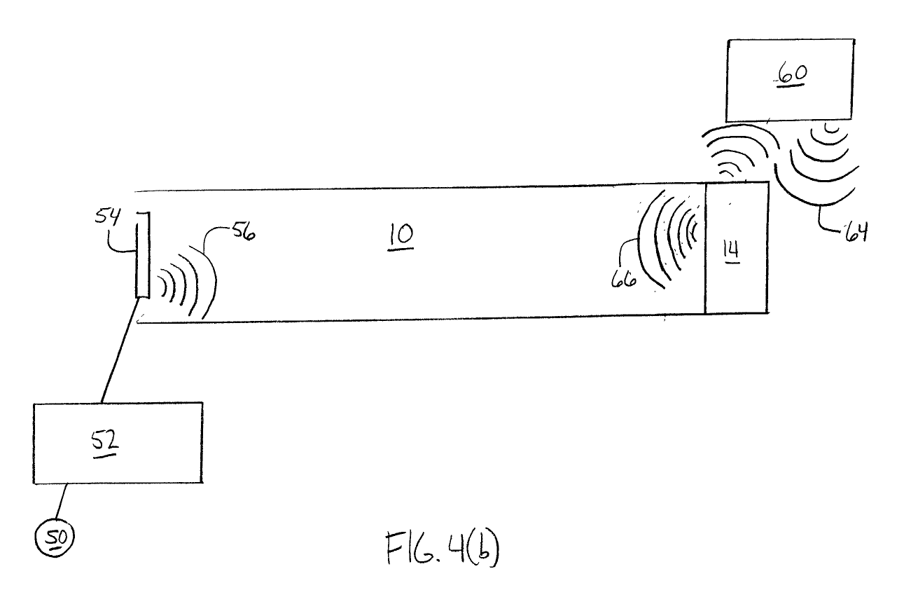

FIGS. 4(a) and 4(b) are schematic representations of an entire radio communications system. In FIGS. 4(a) and (b), a user 50 is connected, through a switch or end-office 52 of a telecommunications service provider. The telecommunications service provider could also be connected to any existing telecommunications network (e.g. the public switched telephone . network (PSTN)). The switch or end-office 52 is connected to a transmitter/receiver 54 proximate to an intrinsic pavement transmitter and antenna 10. It is noted that the transmitter/receiver 54 could be located at a point in, on, or adjacent to the intrinsic pavement transmitter and antenna 10.

In FIG. 4(a), the transmitter/receiver 54 radiates a radio signal 56. The radio frequency 56 is conducted along the intrinsic pavement transmitter and antenna 10 until it reaches another transmitter/receiver 58. The second transmitter/receiver 58 is also proximate the intrinsic pavement transmitter and antenna 10. The second transmitter/receiver 58 is shown as connected to an end-user 60 through a hard wire 62. However, rather than utilizing a second transmitter/receiver 58 hard wired to an end-user 60, a signal could be communicated to and from an end-user 60 through radio frequencies. In FIG. 4(b), these radio frequencies 64 are shown as being emitted, and received by, a conductive surface 14 of the intrinsic pavement transmitter and antenna 10.

In both embodiments, a signal is communicated to an end-user 60, which, in turn, emits a signal 66 that is transmitted back along the intrinsic pavement transmitter and antenna 10 until received by the first transmitter/receiver 54. As would be apparent to one skilled in the art, the basic structure outlined in FIGS. 4(a) and (b) can be repeated to provide additional geographical reach.

It is noted that the foregoing discussion of the present invention has focused primarily on its application in roadways and paved lots. However, conductive asphalt could also be used in roofing materials for houses or other structures.

Numerous modifications and alternative arrangements may be devised by those skilled in the art without departing from the spirit and scope of the present invention and the appended claims are intended to cover such modifications and arrangements. Thus, while the present invention has been described above with particularity and detail in connection with what is presently deemed to be the most practical and preferred embodiments of the invention, it will be apparent to those of ordinary skill in the art that numerous modifications, including, but not limited to, variations in size, materials, shape, form, function, manner of operation, assembly, and use may be made without departing from the principles and concepts set forth herein.

What is claimed is:

1. A radio communications system comprising:
a) an intrinsic pavement transmitter and antenna;
b) a first transmitter/receiver, at a first point along the intrinsic pavement transmitter and antenna, and in communication with an end-user; and
c) a second transmitter/receiver, at a second point along the intrinsic pavement transmitter and antenna, and in communication with an end-user; wherein the intrinsic pavement transmitter and antenna conducts radio frequency signals between the first and second transmitter/receiver.

2. The radio communications system of claim 1, wherein the second transmitter/receiver is coupled to the end-user with a hard wire.

3. The radio communications system of claim 1, wherein the second transmitter/receiver is a conductive surface portion of the intrinsic pavement transmitter and antenna.

4. The radio communications system of claim 1, wherein the first transmitter/receiver is adjacent to the intrinsic pavement transmitter and antenna.

5. The radio communications system of claim 1, wherein the first transmitter/receiver is located in the intrinsic pavement transmitter and antenna.

6. An intrinsic pavement transmitter and antenna, comprising a roadway, including:
a) a suitable wearing course material; and
b) an effective amount of radio frequency conductive material, sufficient to transmit and receive radio frequencies.

7. The intrinsic pavement transmitter and antenna of claim 6, wherein the radio frequency conductive material is at least one member selected from the group consisting of: radio frequency transmittable polymers, metal shavings, metal dust and conductive carbons.

8. The intrinsic pavement transmitter and antenna of claim 7, wherein the conductive carbon is at least one member selected from the group consisting of carbon black, carbon fiber, graphite and coke breeze.

9. The intrinsic pavement transmitter and antenna of claim 7, wherein the radio frequency transmittable polymers include: polyacetylene, polyaniline, polypyrrole, polythiophenes, polyethylenedioxythiophene and poly(p-phenylene vinylene)s.

10. The intrinsic pavement transmitter and antenna of claim 7, wherein the metal shavings are at least one member selected from the group consisting of: iron, iron alloys, aluminum, aluminum alloys, copper and copper alloys.

11. The intrinsic pavement transmitter and antenna of claim 7, wherein the metal dust is at least one member selected from the group consisting of: iron, iron alloys, aluminum, aluminum alloys, copper and copper alloys.

12. The intrinsic pavement transmitter and antenna of claim 6, wherein the suitable wearing course material is at least one member selected from the group consisting of: asphalt and concrete.

13. The intrinsic pavement transmitter and antenna of claim 6, wherein the conductive material is intermixed with the wearing course material.

14. The intrinsic pavement transmitter and antenna of claim 6, wherein the conductive material and the wearing course material are substantially distinct layers.

15. The intrinsic pavement transmitter and antenna of claim 6, further comprising an insulating layer proximate the roadway.
